(19) United States
(12) Patent Application Publication
(10) Pub. No.: US 2004/0172296 A1
(43) Pub. Date: Sep. 2, 2004

(54) Data structures for context based rule application

(75) Inventor: Eric Wohl, Austin, TX (US)

Correspondence Address: TOLER & LARSON & ABEL L.L.P., 5000 PLAZA ON THE LAKE STE 265, AUSTIN, TX, 78746, US

(73) Assignee: RECARE, Inc.

(21) Appl. No.: 10/725,948

(22) Filed: Dec. 2, 2003

Related U.S. Application Data
(60) Provisional application No. 60/430,420, filed on Dec. 3, 2002.

(51) Int. Cl. G06F 17/60

(52) U.S. Cl. 705/2

(57) ABSTRACT

In one particular embodiment, the disclosure is directed to a system that includes a processor, a database accessible to the processor, and storage media. The database includes a relationship table identifying a relationship of at least one pair of medical findings. The storage media stores instructions operable to direct the processor to retrieve the relationship of the at least one pair of medical findings and instructions operable to direct the processor to generate graphical user interface data based on the relationship.

### CROSS-REFERENCE TO RELATED APPLICATION(S)

The present application claims priority from U.S. provisional patent application No. 60/430,420, filed Dec. 3, 2002, entitled “Data structures for context based rule application,” naming inventors J. D. Stewart, Eric Wohl and Randolph Lipscher, which application is incorporated by reference herein in its entirety.

### TECHNICAL FIELD

The disclosed matter relates, in general, to context sensitive data usage. More specifically, the disclosure relates to the organization of data for pairing medical findings.

### BACKGROUND OF THE INVENTION

Electronic medical records (EMR) systems have been developed for collecting medical data. The systems collect and store data associated with administrative information, insurance information, and patient information.

Generally, EMR systems have an interface formed with static pages. To create and manage an EMR system interface, considerable effort is extended to maintain links and adjust page elements.

The results of an examination or visit may be documented. Typical EMR systems utilize manual coding to convert between examination findings and billing codes. Entering the codes is time consuming and expensive. Moreover, errors in data entry lead to delays in payment by insurance companies and government provided medical assistance programs.

As such, many medical records systems suffer from deficiencies in providing interfaces and coded references to examination findings. Therefore, an improved EMR system would be desirable.

### SUMMARY OF THE INVENTION

In one particular embodiment, the disclosure is directed to a system that includes a processor, a database accessible to the processor, and storage media. The database includes a relationship table identifying a relationship of at least one pair of medical findings. The storage media stores instructions operable to direct the processor to retrieve the relationship of the at least one pair of medical findings and instructions operable to direct the processor to generate graphical user interface data based on the relationship.

In another exemplary embodiment, the disclosure is directed to a device that includes a processor, a display medium, and storage media accessible to the processor. The storage media includes instructions operable to direct the processor to display a graphical user interface based on at least one relationship of a pair of medical findings.

In a further exemplary embodiment, the disclosure is directed to a method of providing a medical encounter graphical user interface. The method includes retrieving data associated with a relationship of at least one pair of medical findings from a database and generating graphical user interface data based on the relationship.

In another exemplary embodiment, the disclosure is directed to a storage media including computer operable instructions stored in a computer readable memory. The computer operable instructions direct computational circuitry to retrieve data associated with a relationship of at least one pair of medical findings from a database and to generate graphical user interface data based on the relationship.

### BRIEF DESCRIPTION OF THE DRAWINGS

FIG. 1 depicts inheritance of a medical class.

FIG. 2 illustrates an exemplary embodiment of a class.

FIG. 3 illustrates an exemplary finding for an exemplary class.

FIG. 4 is a pictorial of an exemplary finding location.

FIG. 5 is a diagram depicting exemplary associations of findings.

FIGS. 6A, 6B, 6C, and 6D are diagrams depicting exemplary finding relationships, according to the invention;

FIGS. 7, 8, 9, and 10 depict exemplary organizations of data.

FIGS. 11, 12, and 13 depict exemplary systems for providing an interface and acquiring data.

FIG. 14 illustrates an exemplary method for providing an interface.

FIGS. 15 and 16 depict exemplary interfaces.

### DETAILED DESCRIPTION

In medical examinations and data collection associated with medical records, the data collected and the method for referring to that data has a context sensitive nature. Location on the body and the type of finding can have implications in presentation, linguistic, and coding reference, among others. For presentation reference, the finding may have an associated control such as a check box, bi-state control element, or tri-state control element. For linguistic reference, the finding may have various phrases associated with it when referring to it in the positive or negative or when discussing it in a summary or narrative. For coding, the finding may have various rules associated with it for determining medical codes and billing codes.

When examining patients, there are over 700 body parts with 7000 conditions associated with various parts. Cataloging the total number of parts would require references to several hundred thousand complex findings. The number of findings and context data leads to a large database. Large databases typically have slow access time and large storage requirements. These slow access times delay responsiveness to commands. For example, doctors may experience a delay when entering and retrieving data from the system.

Medical records systems having graphical and linguistic displays may display a large variety of screens to enable medical professionals, patients, and insurance and government personnel to enter data concerning the human body. The human body has a large number of parts. Each part may have various associated ailments and qualities indicative of a patient's status and health. In addition, various tests, medical history data, patient profile data, prescriptions, and insurance data may be stored in the system, each having a variety of associated status and results parameters.

An object-oriented data model may be used to characterize, catalog, and associate findings. This object-oriented data model may be implemented in a relational database, object-oriented database, or object-oriented program coding. The data model may be used to dynamically generate an interface for entering, storing, and encoding encounter findings. In addition, the data model may be used in medical and billing coding, research, artificial intelligence, and narrative generation.

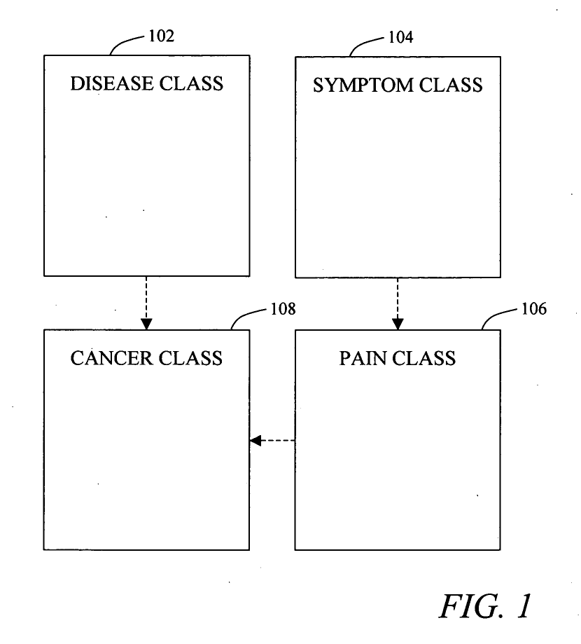

FIG. 1 depicts an exemplary data model. Base classes for disease 102 and symptoms 104 may be developed. In addition, other classes may be developed social history, family history, testing, pharmacology, and other base data sets. These classes may be used to build classes utilizing inheritance. For example, the symptom class 104 may be used to build a pain class 106. The pain class may inherit data, characteristics, and logic from the base symptom class 104.

In another example, a cancer class 108 may be derived from the disease class 102. The cancer class 108 may also include data elements derived from the pain class 106. In this manner, more complex classes may be developed. For example, the cancer class 108 may be used to build a breast cancer class (not shown).

The object-oriented data model may, for example, exhibit the features of a object or class, such as inheritance, overloading, and public and private data and logic. However, the data model may or may not include each of these features.

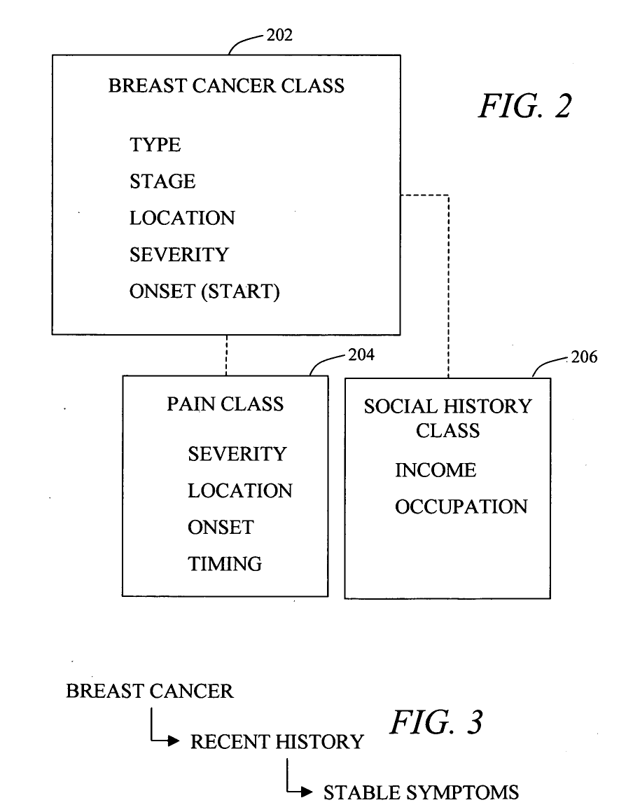

FIG. 2 depicts an exemplary class 202 for breast cancer. Diagnosis and examination of breast cancer may have associated data including type, stage, location, severity, and onset. For example, type may include ductal carcinoma, lobular carcinoma, estrogen receptor positive, adenocarcinoma, inflammatory carcinoma, cystosarcoma phylloides, invasive medullary carcinoma, invasive tubular carcinoma, other breast carcinoma, and unspecified breast carcinoma. Stage may include 0, I, II, III, IIIB, and IV. Other data may be associated with the cancer, such as status, grade, tumor marker present, and detection method.

In addition, data may be collected that relates to other classes, such as pain 204 and social history 206. A pain class 204 may, for example, include data relating to severity, location, onset, and timing. In some cases, such as, for example, severity and location, the data may overlap with that collected for the larger class, such as the breast cancer class 202. In some cases, such as, for example, onset, the data may have a similar label, but relate to differing events, such as the discovery of a cancer and the onset of pain.

Classes, such as social history 206 or family history (not shown), may provide additional context to a finding. For example, knowledge relating to healthy worker phenomena or existence first-degree relative with breast cancer, may aid in diagnosing and treating diseases.

The data model may also apply to situations such as metastasized tumors and cancers. For example, breast cancers may metastasize to form brain tumors. A brain tumor class may be used for representation of both a benign brain tumor and a metastasized breast cancer. In this manner, duplication of a class is prevented by previously developed classes.

Classes derived from similar parent classes may have common characteristics, data sets, and logic. FIG. 3 depicts an exemplary relationship that may be used in a variety of tumor classes. For example, “breast cancer” may have a related finding of “recent history.” “Recent history” may have a related finding of “stable symptoms.” Other cancer classes may also have a relationship to “recent history” and may further utilize the relationship of “recent history” to “stable symptoms.”

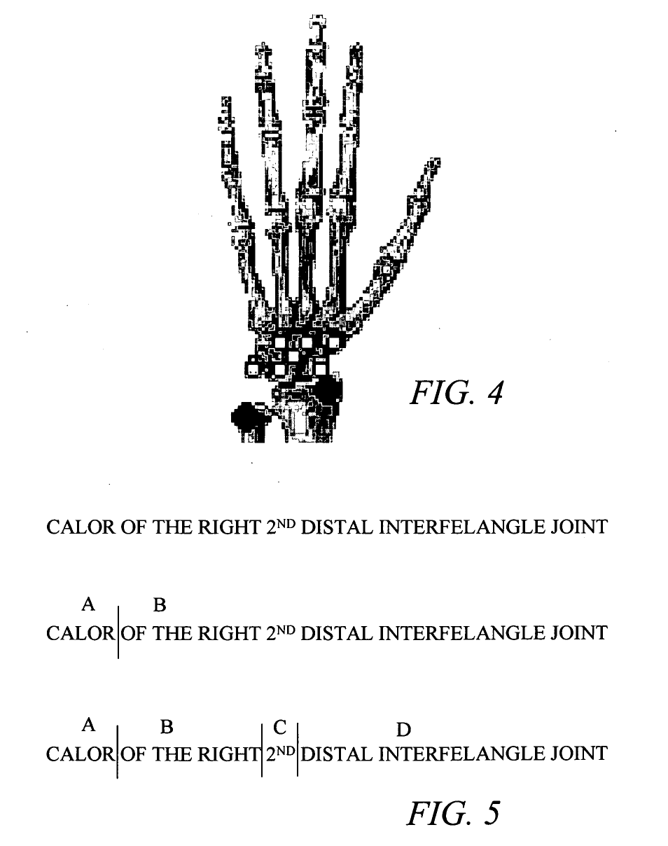

FIGS. 4, 5, 6A, 6B, 6C and 6D depict a relationship of a symptom. FIG. 4 is a pictorial of one exemplary location on the body, the hand. The hand may be subdivided into various sections, the palm, fingers, and the back of the hand, among others. Each finger may be further subdivided into joints, fingernails, and subsections. In addition, there are two hands, a right and a left.

Each part may have a variety of ailments or conditions associated with it. For example, joints may exhibit swelling, heat, rigidity, dislocations, and various other conditions. Other sections of the finger may exhibit swelling, cuts of varying lengths, and other conditions. The representation of each of these ailments or conditions for each of the locations or body parts with which it may be associated leads to a large number of possible combinations. Moreover, the ailments or conditions may have differing linguistic references or graphic representations depending on the context of the ailment or condition. Furthermore, various coding rules may be applicable to these ailments or conditions depending on their context.

For example, a wound in the skin may be linguistically referred to as a scrape, laceration, cut, incision, or puncture, among others, depending on the context. Further, the wound may be associated with differing medical and billing coding rules depending on location, size, and treatment. Several lacerations on an extremity may be treated differently for billing purposes than lacerations on the scalp. A laceration on an arm and two on a leg may have different billing rules than treatment of three lacerations on an arm.

Similarly, calor may refer to heat, calor, or a warmth (depending on context). The context is therefore made of a variety of findings. These findings include associated conditions, ailments, corporal location, medical history, patient data, testing, prescriptions, and other medical data.

FIG. 5 represents the subdivision of an ailment or condition into findings. Calor of the right second distal interphalangeal joint may be subdivided into “calor” and “the right second distal interphalangeal joint.” Alternately, it may be subdivided into “calor,” “right,” “second,” “distal,” and “interphalangeal joint.” However, various subdivisions may be envisaged. Further, other locations, conditions, and ailments may be subdivided in differing manners.

What provides context to the symptom, “calor,” is the location in the right second distal interphalangeal joint. “Calor” may be referred and represented differently if located on the forehead or chest. Various linguistic terms such as heat or fever may be used in place of “calor” depending on the context. In addition, differing graphic overlays or representations may be used depending on the location about the body.

Moreover, stating the existence of calor in the positive or the absence of calor in the negative may have differing priorities and linguistic phrases. For example, when preparing a summary or narrative, noting the lack of a fever may be more important than noting a lack of calor in each joint of the hand.

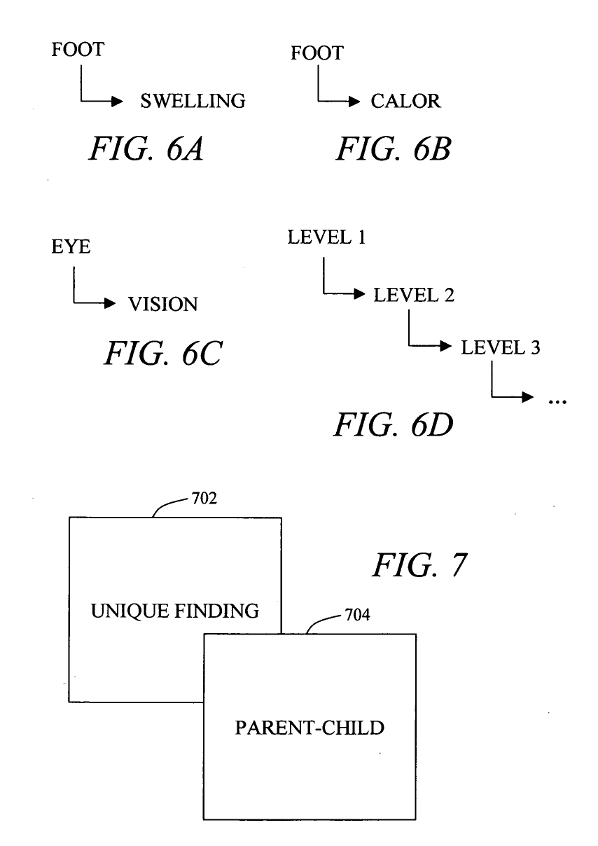

FIGS. 6A, 6B, 6C, and 6D depict context and relationships. For example, a location of the body may give context to a condition. FIG. 6A depicts the location “foot” providing context to “swelling.” Similarly, a “foot” may provide context to “calor” as seen in FIG. 6B. As such, a location finding may have various findings associated with it. In addition, a condition or ailment finding may have various locations with which it may be associated. Moreover various conditions may give context to each other, such as swelling in conjunction with calor.

The findings and finding relationships give context for linguistic and graphical representation. The finding relationships may also give context for the application of billing and coding rules. For example, with a point system for determining billing, an extremity such as a leg, including the foot, may have an associated point limit. However, other ailments or complaints may have differing rules applied to them such as no limits or a differing number of points. For example, the eye may have vision associated with it, as seen in FIG. 6C. Vision may be treated with rules that differ significantly from a laceration on an extremity, for example.

These finding relationships may be categorized in a hierarchical relationship such as a parent-child relationship or a level relationship. FIG. 6D depicts a level relationship with various numbers of levels. For example, “calor” may have a certain context when associated generally with a joint. However, the context may further change when that joint is the right second distal interphalangeal joint.

In a relational representation, symptoms may have an associated location. Treatment of the symptom for graphical representation, linguistic reference, and coding may depend on the location. The relationship may, in some cases, be reversed when the finding is a disease, such as Arthritis where a symptom such as swelling or calor gives context to the disease.

Findings information includes information about the current patient. Examples of such information include complaint onset, complaint duration, complaint quality, complaint severity, causes of complaint, relievers of complaint, review of systems, physical condition, history, active problems, past problems, test results, current medications, demographic information, diagnosis, and prescribed medications. In an exemplary embodiment, this information is encoded so that each finding is associated with a unique identifier in a medical nomenclature framework. These identifiers may be associated in an object-oriented data model or a relation database. In another embodiment, findings are encoded as Booleans (representing present/not present for example), tri-state (present/not present/no-comment, for example), integer values, and character strings.

The findings and relationships may be stored in various data files, such as a relational database or an object database. These files may then be accessed to provide a display, develop narratives or summaries, determine billing and medical coding such as Healthcare Information and Financing Administration codes, and store encounter data. By determining unique findings, a default reference, representation, and rule set may be established. These references, representations, and rule sets may then be altered or replaced when a context or finding relationship dictates.

FIG. 7 is an exemplary embodiment of data files. The data may be stored in two files or subsets of a file. The data may be stored in a database, text files, binary files, and spreadsheets, among others. For example, the data may be stored as two or more tables. One table is a unique finding table; the other table is a parent-child table. The unique finding table stores a list of findings associated with default data. The parent-child table stores data associated with related findings.

The system may apply rules to the use of data in the tables. For example, when creating a display associated with a set of associated findings, the system may check the parent child table for display data. If no parent child relationship exists, the system may use the default display data stored in the unique finding table. Similarly, insurance and billing code data or rules may be applied if found in the parent-child table and alternately use the default data of the unique finding table. In another example, priority may be given to narrative or summary language stored in the parent-child table.

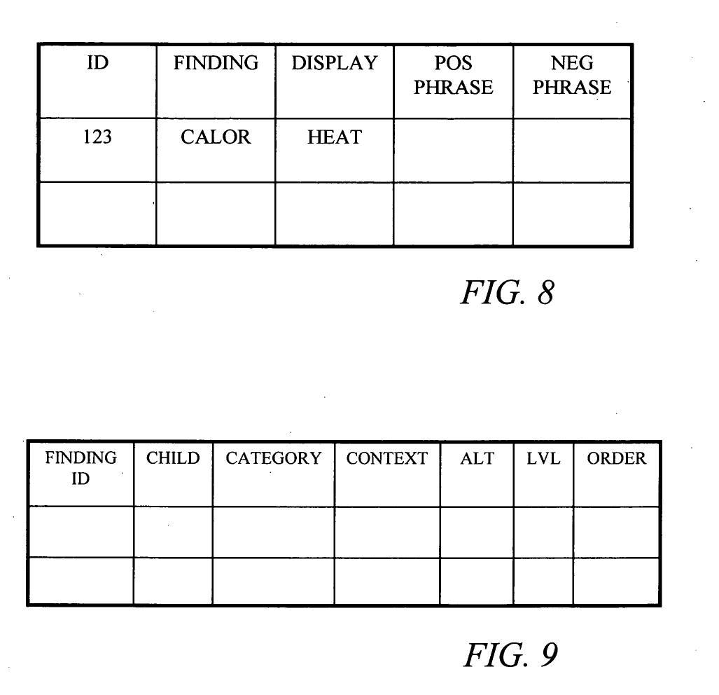

FIG. 8 depicts a table of stored data associated with a unique findings table. In this exemplary embodiment, the table stores data associated with findings such as a finding identifier, a display name, a positive phrase for a narrative or summary, and a negative phrase for a narrative or summary. However, a unique finding table may contain default billing and insurance codes, other display data, such as control parameters, and links.

FIG. 9 depicts a table of stored data associated with a parent-child table. The table may include a finding identifier, a child identifier, a category, context data, an alternate name, level data, and a child order, among others. The finding identifier indicates the parent while the child identifier indicates the child in the relationship. In an alternate embodiment, the table may also include a unique identifier for the relationship pair. Category data may indicate where the data is to be applied. For example, the category data may indicate whether the data applies to a history of present illness display, the physical exam, a narrative, prescriptions, and insurance and billing coding, among other applications. The context may indicate a further relationship. For example, the parent-child data may be applied if and only if the relationship is derived from a higher-level finding. Alternately, level may be used to determine when data associated with the parent-child relationship is to be used. For example, the parent-child data may only apply if the relationship occurs when associated with 2 other levels of findings.

The alternate name may be an alternate display name when the finding is displayed in association with the parent finding. However, other data may be included in the alternate name field such as rules, codes, links, and phrases, among others. Other data may be included, such as control parameters or types. For example, data may be used to indicate the use of a bi-state or tri-state control element in a graphical user interface.

The child order data may be used to specify if the alternate data should be used when the findings are associated in the reverse order, such as in the case of a symptom with a location or an ailment location with a symptom. Various other data fields may also provide information regarding how, when, and what data to apply if two or more findings are associated with each other.

In one exemplary embodiment, the finding relationships reduce representation of redundant information. For example, the “recent history” relationships of FIG. 3 may be used for more than one cancer, such as breast cancer, colon cancer, prostate cancer, and lung cancer. Utilizing reversible pairings such as swelling associated with a foot and a foot associated with swelling reduces database size.

The findings and finding relationships arise in various situations including entry page displays, billing and insurance coding, narratives and summaries, and reports, among others. For example, the findings and relationships may arise in association with recording a patient encounter. Each encounter may be associated with various data. For example, an encounter may be associated with history of present illness (HPI) data. Each data may include findings. In addition, encounters may be associated with complaints, encounter finding, encounter finding modifiers, and test data, among others.

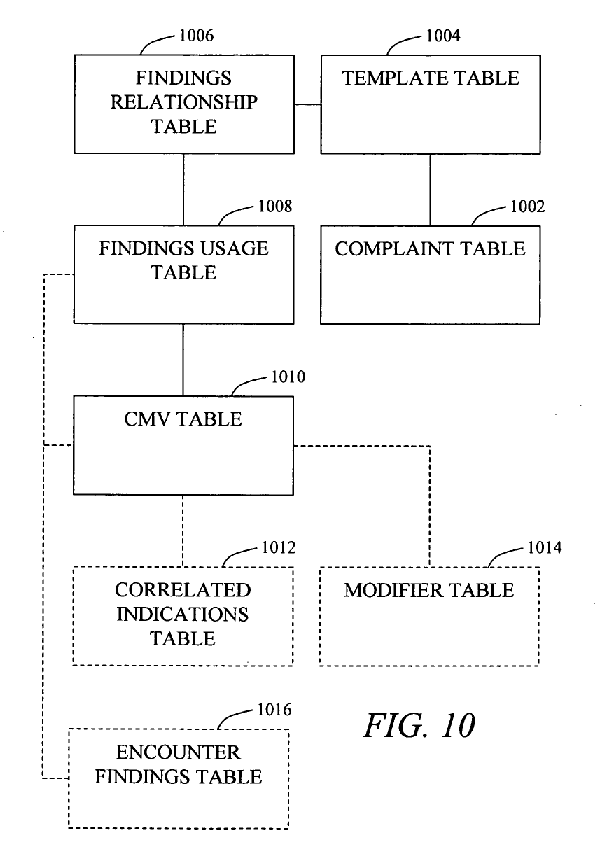

FIG. 10 depicts an alternate method of storing the data model and constructing a graphical user interface (GUI) utilizing the data structures. A listing of complaints may be stored in a complaint table 1002. For example, breast cancer or Arthritis may be considered a complaint. Several data entry templates may be associated with each complaint. For example, a breast cancer complaint may have an associated history of present illness (HPI) template and a review of systems (ROS) template. The template table 1004 may store a listing of templates associated with each complaint. For example, the template table 1004 may store unique identifiers for each template and a data field for the associated complaint.

Template information is information that prompts or enables the user to enter findings information and is selected for display based on criteria including the patient's chief complaint (e.g. “chest pain” or “sore throat”), or the current task (e.g. “history of present illness” or “selected diagnosis”), or both. Template information to be displayed may also be selected based on factors such as demographic information about the patient, clinic, physician specialty, or physician preferences. Templates may be identified in the template table 1004. Information associated with the template such as template information may be derived from finding relationships and metadata associated with those relationships.

The finding relationship table 1006 may store findings and relationships. Some of the relationships may be the template relationship to findings associated with the template. For example, a “breast cancer” HPI template may have a relationship with “recent history.” The findings relationship table 1006 may also store other finding relationships. For example, “recent history” may have a relationship with “stable systems.” The finding relationships table 1006 may also provide each relationship with a unique identifier. In one embodiment, the finding relationships table 1006 may provide context data such as names, level usage, order usage, control element parameters, coding, positive narrative text, and negative narrative text.

In an alternate embodiment, some of the context data may be stored in the finding relationships table 1006. Other context data may be stored in the finding usage table 1008. The finding usage may store the context data such as names, level usage, order usage, control element parameters and types, coding, positive narrative text, negative narrative text, and other metadata. The context data may be associated with the relationship unique identifier. In one exemplary embodiment, the finding usage table 1008 may also include a field for identifying a controlled medical vocabulary identification number.

A controlled medical vocabulary (CMV) table 1010 may also be used. For example, “calor” may have be a controlled medical vocabulary (CMV) term stored in the controlled medical vocabulary table in association with the controlled medical vocabulary identification number. “Calor” may have a set of associated default metadata. However, the default data may be overridden by metadata located in the finding usage table 1008 or the finding relationship table 1006.

In further exemplary embodiments, tables such as a correlated indications table 1012 or modifier table 1014 may be included. The CMV identifier may be used as a key into tables, such as the correlated indications table 1012, which lists potentially correlated findings, such as race and disease. Other tables, such as the modifier table 1014, may include relationships such as location-based associations to the CMV term. For example, “vision” may only be associated with the eye while “calor” may be associated with joints or, generally, with fever.

In one particular embodiment, the data tables may also include an encounter findings table 1016. The encounter findings table 1016 may store data gathered from the GUI created with the data of tables 1002, 1004, 1006, 1008, and 1010. The encounter findings table 1016 may reference the relationship identification number or the CMV identifier. In another embodiment, the encounter findings table 1016 may also reference the template identifier. The encounter findings table 1016 may include data such as control element state or status associated with a finding or finding relationship. These findings may be associated with a patient through a patient identifier, for example.

An exemplary relational database may also include user tables, user preference tables, customized tables, patient tables, pharmaceutical tables, coding tables, lookup tables, and other data tables.

In one exemplary embodiment, the data structure may be used to generate a GUI for entering patient encounter data. In another exemplary embodiment, the data structure may be used to code encounter data for medical and billing purposes. In a further exemplary embodiment, the data structure may be used to research relationship between ailments and findings. For example, a correlated indications table 1012 may be used to explore possible relationships or correlations between findings. In one exemplary embodiment, a doctor may be encourage by researchers, for example, through paying a reward, for acquiring or filling additional finding data associated with the relationship being explored. Such information may be prompted through the correlated indications table 1012. In another exemplary embodiment, the data structures may be used to generate narratives.

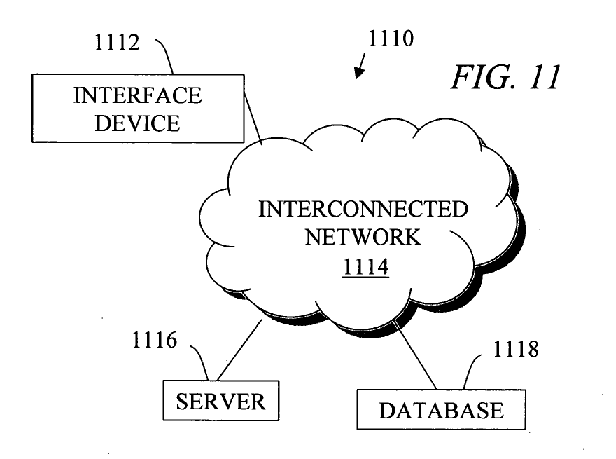

FIG. 11 depicts an exemplary embodiment of a system. The system may include a server 1116 and a database 1118. The database 1118 or server 1116 may include data files associated with findings and finding relationships. The data may be used in accordance with various rules to provide context-sensitive usage of the data. For example, the data may be used to provide context sensitive displays, billing and insurance codes such as Healthcare Information and Financing Administration codes, and summaries and narratives, among others.

In one example, the server may serve an interface over an interconnected network 1114 to an interface device 1112. The interface device 1112 may interpret the interface and provide a display and data entry screen. Depending on the context of the screen, the context of the finding selection, and/or the context of the request, the display may represent various findings in various manners in accordance with the rules and data associated with those findings and associated finding relationships.

However, the server 1116 and database 1118 may or may not be separate. In addition, the interface device 1112 may be combined with the server 1116 and/or database 1118. Moreover, the finding data and finding relationships may be used to provide various outputs including reports, summaries and narratives, prescriptions, history of present illness interfaces, diagnostic interfaces, test reports, billing codes, insurance codes, Healthcare Information and Financing Administrations/Medicare/Medicaid coding, and other data, among others.

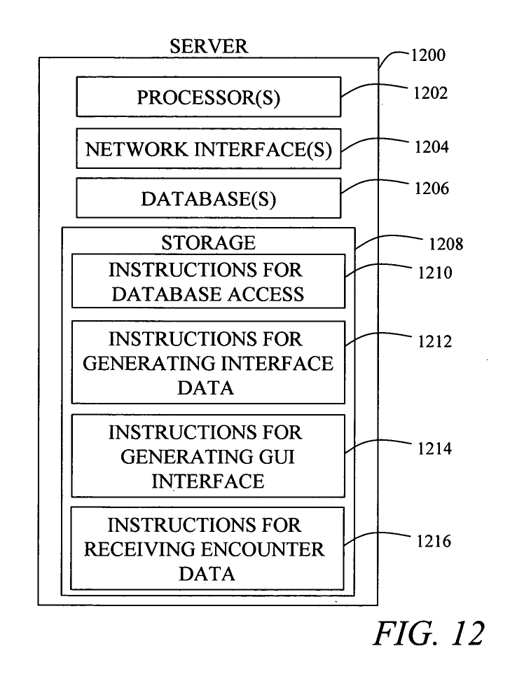

FIG. 12 depicts an exemplary embodiment of a server. The server 1200 includes one or more processors 1202 and one or more network interfaces 1204. The network interfaces 1204 may include wireless and wired interfaces. The wireless interfaces may, for example, include Bluetooth or 802.11 interfaces.

The server 1200 may also include databases 1206. The databases 1206 may be relational databases structured in a manner similar to those of FIGS. 7, 8, and 9, or 10. Alternately, the databases 1206 may be located or housed separately from the server 1200.

The server 1200 may also include storage media 1208. The storage media 1208 may include instructions for accessing database 1210. For example, the instructions may direct the processor 1202 to access the database 1206 to acquire the finding relationships and associated metadata. The storage media 1208 may further include instructions 1212 operable to direct the processor 1202 to generate interface data. The interface data may for example include XML data, HTML data, graphical data, coded data, and other data. For example the instructions 1212 may generate XML data for use by an application to generate a GUI. The server 1200 may include instructions 1214 for generating a GUI based on the interface data and the relationship data. The interface may include HTML pages, ASP code, Java applets, javascripts, PHP, and other interface formats. Alternately, the interface data may be forwarded to an interface device where the data is converted to a GUI. The server 1200 may also include instructions 1216 for receiving encounter data, such as the results of a ROS or HPI encounter. The database access instructions 1210 may be used to store the encounter data in the databases 1206. The server 1200 may further include graphical element data, other instructions, and other data.

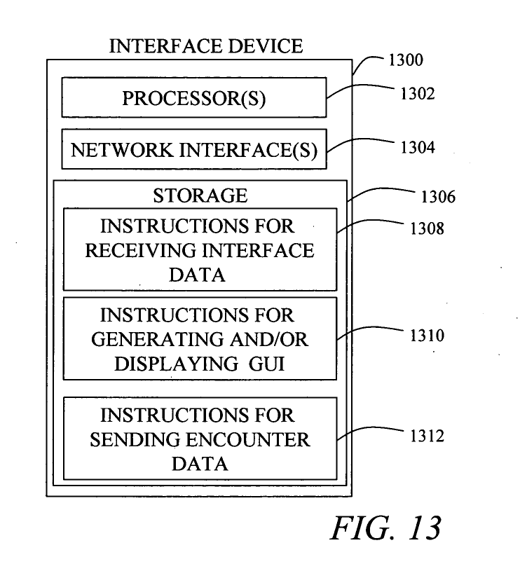

FIG. 13 depicts an exemplary embodiment of an interface device. The interface device 1300 includes one or more processors 1302 and one or more network interfaces 1304. These interfaces may be wireless or wired. In one exemplary embodiment, the interface device is a portable circuitry, such as a tablet computer or handheld PDA.

The interface device 1300 further includes storage media 1306. The storage media 1306 may include instructions for receiving interface data 1308, instructions for generating and/or displaying a GUI from the interface data 1308, and instructions for receiving and sending encounter data 1312. In one exemplary embodiment, the interface data 1308 is an XML file with data useful for building a GUI. In another embodiment, an HTML file or complete GUI is communicated and instructions 1310 display the GUI. For example, instructions 1310 may include a browser.

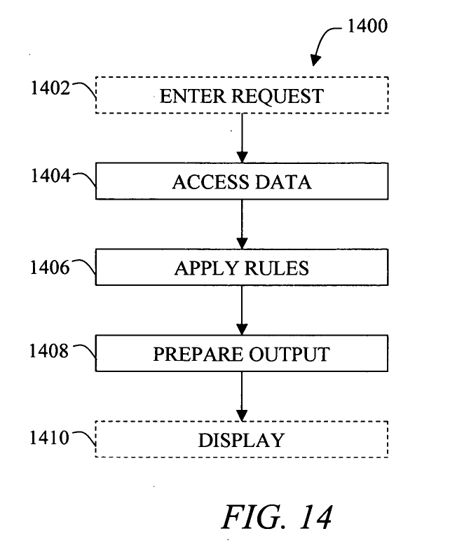

FIG. 14 depicts an exemplary method for use by the system. The method may or may not include a request for data as seen in a block 1402. For example, a user may request a display page. The display page may be associated with findings having context and relationships. The system may access the data files to ascertain the existence of available data as seen in a block 1404. The system then applies the rules to determine how to apply the data. For example, the system may give precedence to data found in a parent-child table over default data found in a unique finding table. Then, the system may prepare the output as seen in a block 1408. The output may be interface data or an interface page. For example, the output may be an interface page that is displayed as seen in a block 14100. However, the output may be a report, summary, narrative, insurance code, or billing code, among others.

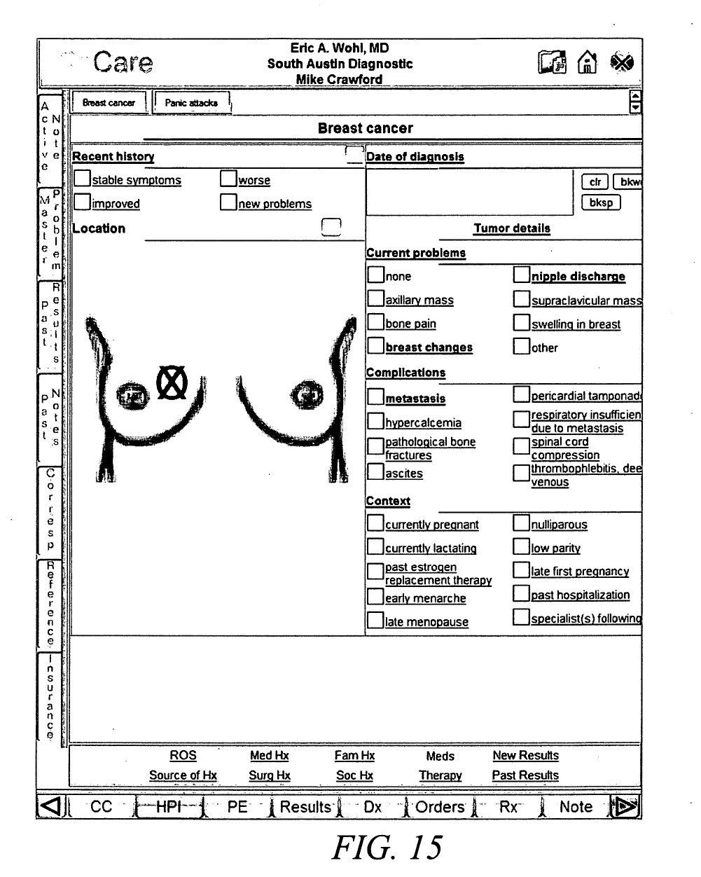

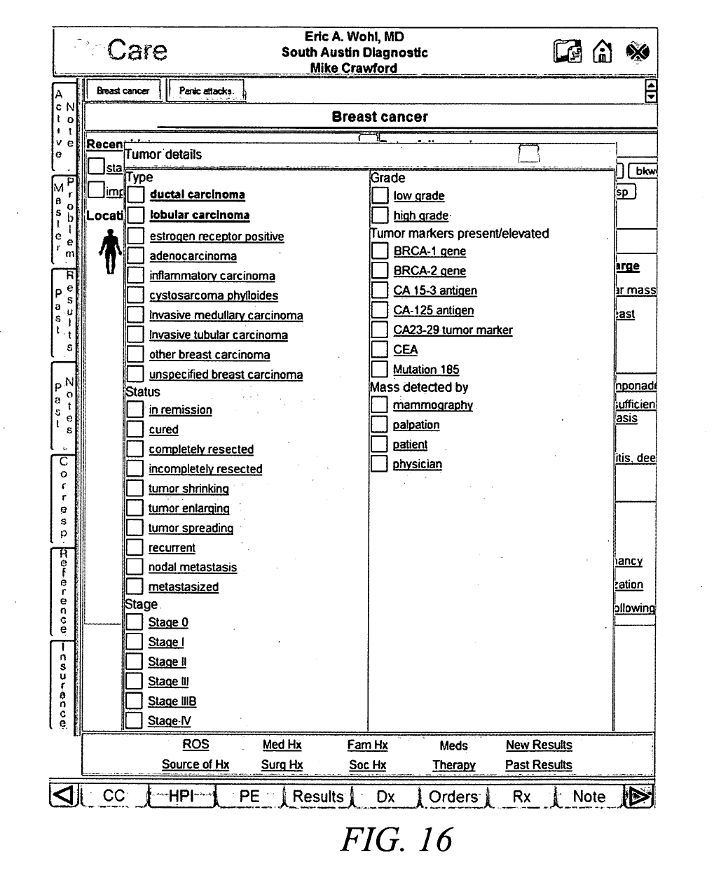

FIGS. 15 and 16 depict an exemplary interface. FIG. 15 depicts a HPI page associated with breast cancer. Finding relationships are used to dynamically generate the GUI. For example, “breast cancer” is associated with “recent history.” “Recent history” is associated with “stable symptoms.” A display is generated with the section heading “Recent History” with control elements and links associated with “stable symptoms.” Metadata associated with the relationships is used to create links and control elements. The interface may include HTML pages, ASP code, Java applets, javascripts, PHP, and other interface formats.

A GUI may include a graphical representation of location, other headings and subheadings, and a variety of control elements, such as text boxes, links, check boxes, and bi-state and tri-state control elements. The GUI may also include patient names, advertising areas, pictorial links, and various graphical elements such as lines, pictures, icons, and tabs.

FIG. 16 depicts the selection of a “Tumor Details” link shown in FIG. 15. The link activates a page having type, status, stage, grade, marker, and detection information. The type may, for example, be breast cancer specific. However, other headings may include aspects generic to tumors or generic to diseases and conditions.

In one particular embodiment, the disclosure is directed to a system for displaying medical data entry pages with context-based information. The system includes a server and data files. The data files include one or more files associated with findings and finding relationships. The files may comprise a database. Rules associated with the files may determine the context based representation associated with finding pairs. The rules may also determine billing codes, summary representations, and data storage, among others. The system may deliver medical data entry pages to entry devices including wireless pads, desktop computers, laptop computers, and handheld computers, among others.

In another embodiment, the disclosure is directed to a context-based interface. The interface may contain code interpretable for displaying varying representations of a finding given its context. The interface may include HTML pages, ASP code, Java applets, javascripts, and PHP, among others.

In a further embodiment, the disclosure is directed to in database structures with at least two tables. One table has a listing of findings with default data. Another table has a listing of finding relationships with alternate data. Priority may be given to data associated with the finding relationships over the default table. In this manner, the finding relationships may used to specify context in which alternate data applies.

In another embodiment, the disclosure is directed to a method for applying rules to finding relations to determine billing codes, billing points, and insurance coding and representations, among others. The system may access the data in a prioritized manner, apply rules to the data, and prepare an output.

The above-disclosed subject matter is to be considered illustrative, and not restrictive, and the appended claims are intended to cover all such modifications, enhancements, and other embodiments, which fall within scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a processor;
a database accessible to the processor, the database comprising:
a relationship table identifying a relationship of at least one pair of medical findings; and
storage media storing:
instructions operable to direct the processor to retrieve the relationship of the at least one pair of medical findings; and
instructions operable to direct the processor to generate graphical user interface data based on the relationship.

2. The system of claim 1, further comprising instructions operable to direct the processor to generate a graphical user interface based on the graphical user interface data.

3. The system of claim 1, wherein the relationship comprises a parent medical finding and a child medical finding.

4. The system of claim 1, wherein the medical findings comprise at least one complaint and at least one diagnosis.

5. The system of claim 1, further comprising a network interface accessible to the processor.

6. The system of claim 5, wherein the storage media further comprises instructions operable to direct the processor to communicate the graphical user interface data to an interface device via the network interface.

7. The system of claim 6, wherein the interface device comprises instructions for generating a graphical user interface based on the graphical user interface data.

8. The system of claim 5, wherein the network interface is a wireless network interface.

9. The system of claim 1, wherein the database further comprises a template table identifying a parent finding associated with the relationship of the at least one pair of medical findings.

10. The system of claim 9, wherein the database further comprises a complaint table identifying a complaint associated with the parent finding.

11. The system of claim 1, wherein the database further comprises a finding usage table identifying metadata associated with at least one of a parent finding and a child finding associated with the relationship of the at least one pair of medical findings.

12. The system of claim 11, wherein the metadata comprises a display text.

13. The system of claim 11, wherein the metadata comprises a control element type.

14. The system of claim 11, wherein the metadata comprises a medical coding.

15. The system of claim 11, wherein the metadata comprises a billing code.

16. The system of claim 11, wherein the database further comprises a controlled medical vocabulary table.

17. The system of claim 1, wherein the database further comprises a encounter findings table identifying an encounter finding associated with the relationship of the at least one pair of medical findings.

18. The system of claim 17, wherein the storage media further comprises instructions operable to direct the processor to receive the encounter finding and store the encounter finding in the encounter findings table.

19. The system of claim 17, wherein the storage media further comprises instructions operable to direct the processor to determine a billing code associated with the encounter finding.

20. The system of claim 17, wherein the storage media further comprises instructions operable to direct the processor to determine virtual consultant data based on the encounter finding.

21. A device comprising:
a processor;
a display medium; and
storage media accessible to the processor, the storage media comprising:
instructions operable to direct the processor to display a graphical user interface based on at least one relationship of a pair of medical findings.

22. The device of claim 21, wherein the storage media further comprises instructions operable to direct the processor to generate the graphical user interface based on the at least one relationship.

23. The device of claim 21, wherein the storage media further comprises instructions operable to direct the processor to communicate data associated with the graphical user interface.

24. The device of claim 21, wherein the at least one relationship comprises a parent medical finding and a child medical finding.

25. The device of claim 21, wherein the medical findings comprise at least one complaint and at least one diagnosis.

26. The device of claim 21, wherein the device comprises wireless portable computational circuitry.

27. The device of claim 21, wherein the device comprises tablet computational circuitry.

28. The device of claim 21, wherein the device comprises a personal digital assistant.

29. A method of providing a medical encounter graphical user interface, the method comprising:
retrieving data associated with a relationship of at least one pair of medical findings from a database; and
generating graphical user interface data based on the relationship.

30. The method of claim 29, further comprising generating a graphical user interface based on the graphical user interface data.

31. The method of claim 30, further comprising communicating the graphical user interface to a user device.

32. The method of claim 29, further comprising communicating the graphical user interface data.

33. The method of claim 29, further comprising:
receiving data associated with the relationship and an encounter; and
storing the data in an encounter finding table in the database.

34. The method of claim 33, wherein the encounter comprises attendance to a patient by a medical professional.

35. Storage media comprising:
computer operable instructions stored in a computer readable memory, the computer operable instructions to direct computational circuitry to:
retrieve data associated with a relationship of at least one pair of medical findings from a database; and to
generate graphical user interface data based on the relationship.

36. The storage media of claim 35, further comprising instructions to generate a graphical user interface based on the graphical user interface data.

37. The storage media of claim 36, further comprising instructions to communicate the graphical user interface.

38. The storage media of claim 35, further comprising instructions to:
receive data associated with the relationship and an encounter; and
store the data in an encounter finding table in the database.
